(19) United States
(12) Patent Application Publication
(10) Pub. No.: US 2021/0240804 A1
(43) Pub. Date: Aug. 5, 2021

(54) AUTHENTICATION SYSTEM

(71) Applicant: TOYOTA JIDOSHA KABUSHIKI KAISHA, Toyota-shi (JP)

(72) Inventor: Minoru KUBOTA, Toyota-shi (JP)

(73) Assignee: TOYOTA JIDOSHA KABUSHIKI KAISHA, Toyota-shi (JP)

(21) Appl. No.: 17/074,680

(22) Filed: Oct. 20, 2020

(30) Foreign Application Priority Data
Feb. 3, 2020 (JP) 2020-016618

(51) Int. Cl. G06F 21/31; B60R 25/24

(52) U.S. Cl. CPC G06F 21/31; B60R 25/246

(57) ABSTRACT

An authentication system that includes a first information processing device and a second information processing device for requesting an authentication device to perform first authentication based on a challenge-response method. The first information processing device performs second authentication with the second information processing device and requests the authentication device to issue a challenge on condition that the second authentication is established. The second information processing device generates a response corresponding to the challenge issued by the authentication device.

### CROSS-REFERENCE TO RELATED APPLICATION

This application claims priority to Japanese Patent Application No. 2020-016618 filed on Feb. 3, 2020, incorporated herein by reference in its entirety.

### BACKGROUND

### 1. Technical Field

The present disclosure relates to the authentication technique.

### 2. Description of Related Art

A car navigation device has the function to prevent theft. For example, when the device is removed by a procedure other than the proper procedure specified by the manufacturer, some commercially available products restrict the use of the device (anti-theft lock) to prevent the device from being started on the assumption that the device has been stolen.

When the anti-theft lock is enabled, some products can be unlocked by performing predetermined authentication. For example, the car navigation device displays a character string to be used as a challenge, and the authenticated server issues a response corresponding to the character string. This challenge-response authentication allows only a legitimate product, which is not stolen product, to be unlocked.

### SUMMARY

However, when an unlimited number of challenges can be issued on the product to be unlocked, there is a risk that the hash function for generating a response can be estimated by a brute force attack.

The present disclosure provides a technique for improving the security of an authentication system.

A first aspect of the present disclosure relates to an authentication system including a first information processing device and a second information processing device for requesting an authentication device to perform first authentication based on a challenge-response method. More specifically, the first information processing device is configured to perform second authentication with the second information processing device and is configured to request the authentication device to issue a challenge on condition that the second authentication is established. The second information processing device is configured to generate a response corresponding to the challenge issued by the authentication device.

A second aspect of the present disclosure relates to an authentication system including an authentication device, a first information processing device, and a second information processing device. More specifically, the authentication device is configured to issue a challenge, to acquire a response corresponding to the challenge, and to perform first authentication based on the issued challenge and the acquired response.

The first information processing device is configured to perform second authentication with the second information processing device and is configured to request the authentication device to issue a challenge on condition that the second authentication is established. The second information processing device is configured to generate a response corresponding to the challenge issued by the authentication device.

Other aspects include an authentication method performed by the authentication system described above, a program that causes a computer to perform the authentication method, or a non-transitory, computer-readable storage medium that stores therein the program permanently.

According to the present disclosure, security can be improved in the authentication system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing challenge-response authentication;

FIG. 2 is a diagram showing an example of a screen output by a navigation device;

FIG. 3 is a schematic diagram showing an authentication system according to a first embodiment;

FIG. 4 is a module configuration diagram of each component of the authentication system;

FIG. 5 is a flow diagram showing the flow of data among the components;

FIG. 6 is a flow diagram showing the flow of data among the components; and

FIG. 7 is a diagram showing an example of a history table stored in a storage unit in a second embodiment.

### DETAILED DESCRIPTION OF EMBODIMENTS

An authentication system described in an embodiment is a system for unlocking an in-vehicle terminal that is security locked (usage restriction). The in-vehicle terminal is, for example, a car navigation device, but is not limited to thereto.

Some car navigation devices have the security function to prevent theft. For example, when power is not received from the vehicle on such a car navigation device, a security lock (usage restriction) is locked to prevent the car navigation device from being started on the assumption that the device has been stolen. The security lock can be unlocked by entering a password that has been set by the vehicle owner. On the other hand, when the password is unknown, it is necessary to forcibly unlock the security lock. In such a case, the user brings the navigation device to the manufacture to request the unlocking of the security lock.

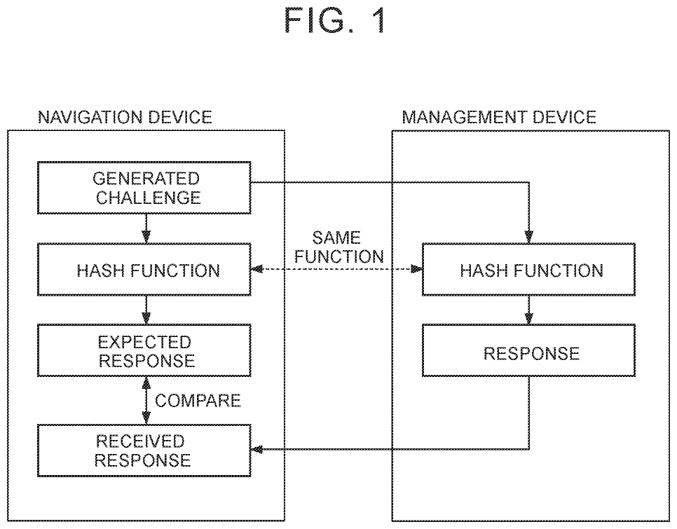

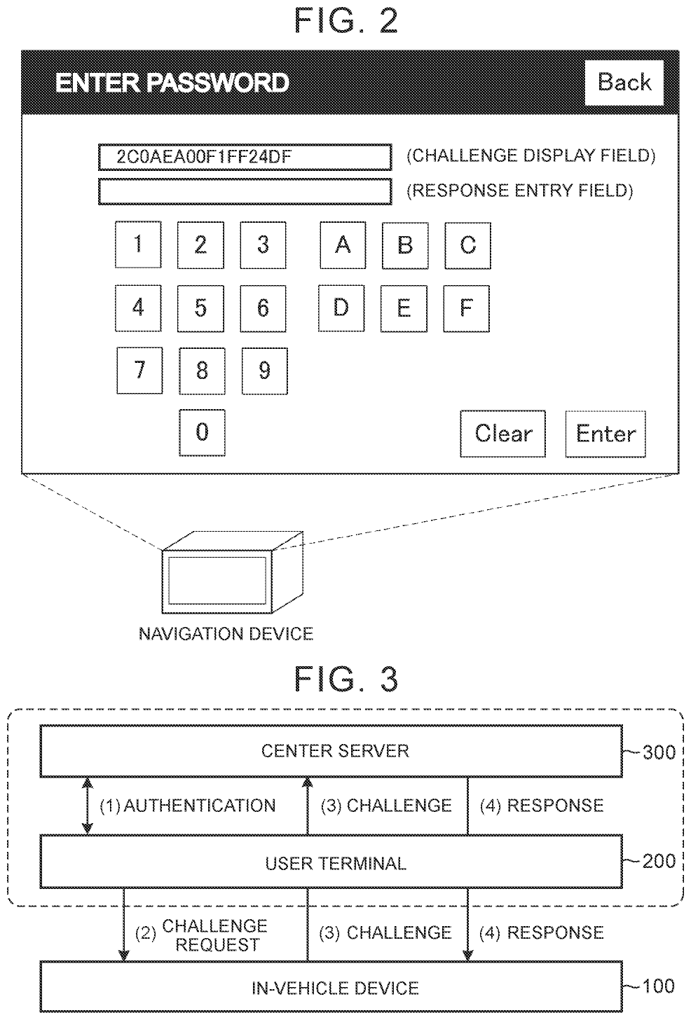

A security lock can be forcibly unlocked mainly by challenge-response authentication. FIG. 1 is a diagram showing challenge-response authentication. More specifically, the navigation device generates a random character string (challenge) and outputs it to the screen as shown in FIG. 2. After confirming that the navigation device was not obtained illegally, the device manufacturer processes the challenge, which has been output, on the computer (management device) to obtain the character string (response) corresponding to the challenge. The response is a character string generated by encoding the challenge using a predetermined hash function. Since both the navigation device and the management device store the same hash function, the navigation device can check whether the generated challenge and the received response match. If the challenge and the response successfully match, the navigation device unlocks the security lock.

A problem with this system is that the system is subject to a brute force attack. For example, as shown in FIG. 2, the navigation device can generate a challenge and verify the response by itself. In other words, a brute force attempt can be made by an automatic input/output operation. In addition, the hash function may be estimated by accumulating the relationship between the challenge and the response.

The present disclosure provides an authentication system for preventing this problem. The authentication system according to the present disclosure is an authentication system including a first information processing device and a second information processing device for requesting an authentication device to perform first authentication based on a challenge-response method. The authentication device is a device that performs predetermined processing based on whether or not the authentication is successful, but is not a device that is specialized for authentication. As described above, the authentication device may be a device that unlocks the predetermined security lock when the authentication is successful. The authentication device is typically an in-vehicle device such as a car navigation device, but is not limited thereto. The authentication system uses a combination of the first information processing device and the second information processing device to allow the authentication device to perform authentication.

More specifically, the first information processing device is configured to perform second authentication with the second information processing device and is configured to request the authentication device to issue a challenge on condition that the second authentication is established, and the second information processing device is configured to generate a response corresponding to the challenge issued by the authentication device.

The first information processing device may be, for example, a device (user terminal) that performs data processing near the authentication device. The second information processing device may be, for example, a secure device (center server) that manages a plurality of first information processing devices.

The first information processing device requests the authentication device to issue a challenge on condition that authentication has been established with the second information processing device. In response to this challenge, the second information processing device generates a response corresponding to the challenge. In other words, unless the second information processing device recognizes the first information processing device as a legitimate device, neither the authentication device issues a challenge nor does the second information processing device issue a response to the challenge. This configuration makes it is possible to solve the problem that an unlimited number of requests can be issued to the authentication device.

In addition, the second information processing device may be configured to generate the response on condition that the second authentication is established. Since the second authentication is required both for issuing the challenge and for generating the response, the security can be improved.

In addition, the first information processing device may be configured to transfer a response to the authentication device. The response is a response generated by the second information processing device. In addition, the first information processing device may be configured to transfer the challenge to the second information processing device to request the second information processing device to issue a response. The challenge is a challenge issued by the authentication device. The challenge and the response, though may be sent and received directly between the second information processing device and the authentication device, may be sent via the first information processing device.

In addition, the authentication system may include a plurality of the first information processing devices and the second information processing device may be configured to store a history of response request reception for each of the plurality of the first information processing devices. For example, there may be a plurality of first information processing devices, for example, one for each user and one for each service providing base. In this case, the second information processing device can count the number of times a response is requested. By doing so, a first information processing device that is performing an illegal operation can be detected.

In addition, the second information processing device may be configured to stop issuing a response for the first information processing device that has requested a response more than a predetermined number of times within a predetermined time. When a response is requested more than the predetermined number of times within the predetermined time, further requests may be rejected as an illegal operation.

In addition, the second information processing device may be a center server that manages the plurality of the first information processing devices. Performing the second authentication by the single center server can eliminate a connection by an unauthorized device.

In addition, the first information processing device may be configured not to present the challenge to an operator. The challenge is the challenge issued by the authentication device. Transferring the issued challenge to the center server without providing it to the operator reduces the risk that the challenge is used for an attack.

The authentication system according to the present disclosure may include an authentication device. In this case, the authentication device may be configured not to issue the challenge in response to a request from a device other than the first information processing device that has received the second authentication. The authentication device can improve security by not accepting a challenge issuance request from other means.

In addition, when the authentication device is removed from a vehicle, the authentication device may be configured to stop a predetermined function thereof until the first authentication succeeds. Stopping other functions (for example, navigation function) until the first authentication is performed makes it possible to provide an effective antitheft measure.

Embodiments of the present disclosure will be described below with reference to the drawings. Note that the following configuration of the embodiments is an example and that the present disclosure is not limited to the configuration of the embodiments.

### First Embodiment

The outline of an authentication system according to a first embodiment will be described below with reference to FIG. 3. An in-vehicle device 100 in this embodiment is a car navigation device having the security lock function. The security lock function in this embodiment is the function that makes it impossible for the car navigation device to be started when the device is removed from the vehicle. This function is provided to prevent an illegal use of the car navigation device when it is stolen. Once the security lock is activated, the in-vehicle device 100 cannot be used unless the challenge-response authentication is performed successfully. The authentication system according to this embodiment is a system for allowing the in-vehicle device 100 to perform challenge-response authentication request for unlocking the security lock. The authentication system includes a user terminal 200 and a center server 300.

The user terminal 200 is a computer for accessing the in-vehicle device 100. The user terminal 200 may be a terminal of an end user or may be a terminal managed by a car dealer or a device manufacturer. The user terminal 200 need not necessarily be under the control of the end user. In this system, there may be a plurality of the user terminals 200. The plurality of user terminals 200 are managed by the center server 300 that will be described later. In the description below, a user terminal that is not managed by the center server 300 is called an unauthorized terminal.

The center server 300 is a server device that manages a plurality of the user terminals 200. In this embodiment, the user terminal 200 functions as an interaction interface between the center server 300 and the in-vehicle device 100, and the center server 300 generates a response. More specifically, the user terminal 200 first sends an authentication request to the center server 300. When the authentication request is received, the center server 300 authenticates the user terminal 200. The authentication method is not limited to a particular method. In this way, the center server 300 confirms that the user terminal 200 is not an unauthorized terminal.

When the authentication is completed, the user terminal 200 sends a challenge issuance request data (challenge request) to the in-vehicle device 100. When the challenge request is received, the in-vehicle device 100 generates a challenge and sends the generated challenge to the user terminal 200. Then, the user terminal 200 relays the received challenge to the center server 300. When the challenge is received, the center server 300 generates a response corresponding to the challenge and sends the generated response to the user terminal 200. Then, the user terminal 200 relays the received response to the in-vehicle device 100.

In the description below, the authentication processing performed by the in-vehicle device 100 (by challenge response) is referred to as first authentication, and the authentication processing performed by the center server 300 for authenticating the user terminal 200 is referred to as second authentication. In the description below, it is assumed that the in-vehicle device 100 is a car navigation device sold as an option by an automobile manufacturer and that the user terminal 200 is a terminal owned by a car dealer. It is also assumed that the center server 300 is a server device managed by an automobile manufacturer for managing a plurality of the user terminals 200.

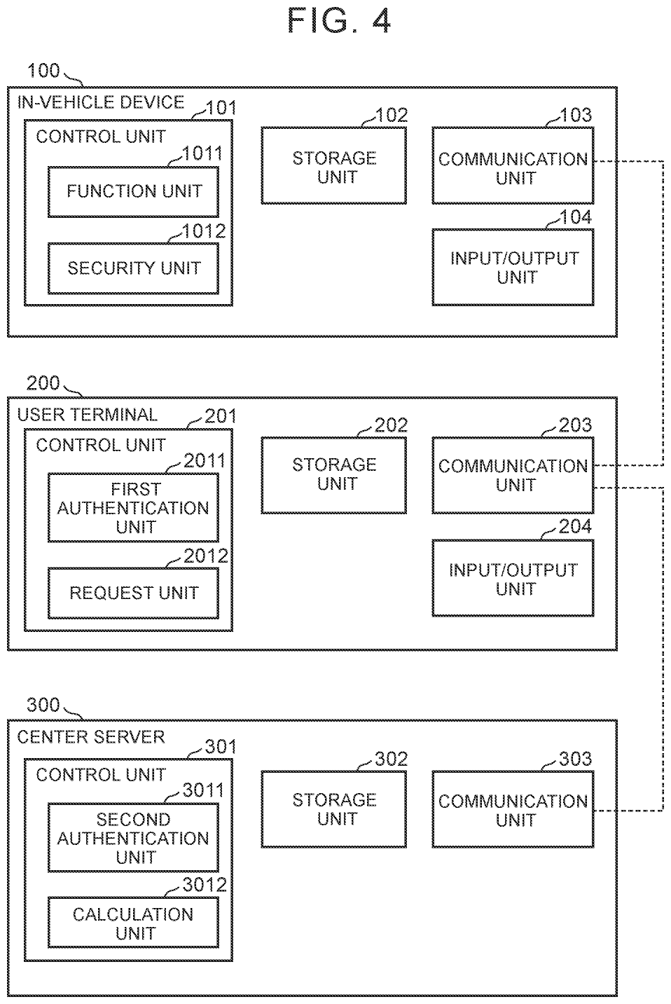

FIG. 4 is a diagram showing a configuration of each component included in the authentication system. The in-vehicle device 100, the user terminal 200, and the center server 300 may each be configured by a general-purpose computer. That is, each device can be configured as a computer having a processor such as a CPU and a GPU, a main storage device such as a RAM and a ROM, and an auxiliary storage device such as an EPROM, a hard disk drive, and a removable medium. The removable medium may be, for example, a USB memory or may be a disc recording medium such as a CD or a DVD. The operating system (OS), various programs, various tables, and the like are stored in the auxiliary storage device. Each program stored in the auxiliary storage device is loaded into the work area of the main storage device for execution therein. Through execution of a program, each component is controlled so that each function, which will be described later, can be implemented to satisfy the predetermined purpose. Note that a part or all of the functions may be implemented by a hardware circuit such as an ASIC or FPGA.

The in-vehicle device 100 is a car navigation device as described above. The in-vehicle device 100 includes a control unit 101, a storage unit 102, a communication unit 103, and an input/output unit 104.

The control unit 101 is an arithmetic unit responsible for the control processing performed by the in-vehicle device 100. The control unit 101 can be implemented by an arithmetic processing unit such as a CPU. The control unit 101 is configured to include two functional modules, a function unit 1011 and a security unit 1012. Each functional module may be implemented by executing the corresponding program, stored in the storage unit 102, by the CPU.

The function unit 1011 provides the main functions of the car navigation device. For example, the function unit 1011 provides the navigation function, audio/visual function, and the like. The security unit 1012 performs the security function. More specifically, when the power supplied from the vehicle to the in-vehicle device 100 is not received, the security unit 1012 enables the security lock. When the security lock is enabled, the function unit 1011 stops its operation. The security unit 1012 is configured to be capable of executing challenge-response authentication (first authentication) when the security lock is enabled. When the challenge-response authentication is successful, the security unit 1012 unlocks the security lock and causes the function unit 1011 to restart its operation.

The storage unit 102 includes a main storage device and an auxiliary storage device. The main storage device is a memory in which a program executed by the control unit 101 and data used by the control program are loaded. The auxiliary storage device is a device in which a program executed in the control unit 101 and data used by the program are stored. A hash function used in challenge-response authentication is stored in the storage unit 102.

The communication unit 103 is a communication interface for communicating with the user terminal 200. The communication standard used by the communication unit 103 may be Wi-Fi (registered trademark) or Bluetooth (registered trademark), or may be a standard based on short-range wireless communication. The in-vehicle device 100 and the user terminal 200 communicate with each other within the line-of-sight distance.

The input/output unit 104 is an interface for inputting/outputting information. The input/output unit 104 includes, for example, a display device and a touch panel. The input/output unit 104 may include a keyboard, a pointing device, a microphone, and the like.

The user terminal 200 includes a control unit 201, a storage unit 202, a communication unit 203, and an input/output unit 204.

The control unit 201 is an arithmetic unit responsible for the control processing performed by the user terminal 200. The control unit 201 can be implemented by an arithmetic processing unit such as a CPU. The control unit 201 is configured to include two functional modules, a first authentication unit 2011 and a request unit 2012. Each functional module may be implemented by executing the corresponding program, stored in the storage unit 202, by the CPU.

The first authentication unit 2011 establishes second authentication with the center server 300. More specifically, the first authentication unit 2011 sends data for receiving authentication (first authentication data) to the center server 300, and receives data indicating that authentication has been established (second authentication data) from the center server 300. The received data is sent to the request unit 2012. The request unit 2012 performs the following three types of processing: processing for sending challenge requesting data (challenge request) to the in-vehicle device 100, processing for relaying a challenge, sent from the in-vehicle device 100, to the center server 300, and processing for relaying a response, sent from the center server 300, to the in-vehicle device 100. A challenge request is generated only when second authentication data is received from the center server 300.

The storage unit 202 includes a main storage device and an auxiliary storage device. The main storage device is a memory in which a program executed by the control unit 201 and data used by the control program are loaded. The auxiliary storage device is a device in which a program executed in the control unit 201 and data used by the program are stored.

The communication unit 203 is a communication interface for communicating with the in-vehicle device 100. The communication unit 203 can communicate with the in-vehicle device 100 using the same communication standard that the communication unit 103 uses. The communication unit 203 is also a communication interface for communicating with the center server 300. The communication unit 203 can communicate with the center server 300 via a wide area network such as the Internet. The communication unit 203 may have interface means (communication module or communication interface) for communicating with the center server 300 via a wide area network.

The input/output unit 204 is an interface for inputting/outputting information. The input/output unit 204 includes, for example, a display device and a touch panel. The input/output unit 204 can input/output information (identifier, password, etc. of the user terminal 200) for performing the second authentication. However, for security reason, the input/output unit 204 preferably should not output the information related to the first authentication. Concealing a challenge generated by the in-vehicle device 100 reduces an attack risk.

The center server 300 includes a control unit 301, a storage unit 302, and a communication unit 303.

The control unit 301 is an arithmetic unit responsible for the control processing performed by the center server 300. The control unit 301 can be implemented by an arithmetic processing unit such as a CPU. The control unit 301 is configured to have two functional modules, a second authentication unit 3011 and a calculation unit 3012. Each functional module may be implemented by executing the corresponding program, stored in the storage unit 302, by the CPU.

The second authentication unit 3011 authenticates the user terminal 200 based on a request from the user terminal 200. More specifically, the second authentication unit 3011 receives first authentication data from the user terminal 200 and performs the second authentication based on the received first authentication data. The authentication may be a method using a common key or a method using a public key. The authentication method is not limited to a particular one. When the second authentication is established, the second authentication unit 3011 sends the second authentication data to the user terminal 200.

The calculation unit 3012 generates a response corresponding to the challenge generated by the in-vehicle device 100. The calculation unit 3012 uses the hash function stored in the storage unit 302, which will be described later, to generate a response corresponding to the challenge generated by the in-vehicle device 100 and sends the generated response to the user terminal 200.

The storage unit 302 includes a main storage device and an auxiliary storage device. The main storage device is a memory in which a program executed by the control unit 301 and data used by the control program are loaded. The auxiliary storage device is a device in which a program executed in the control unit 301 and data used by the program are stored. In addition, the storage unit 302 stores data for authenticating the user terminal 200 (data to be compared with the first authentication data) and the same hash function that is stored in the in-vehicle device 100.

The communication unit 303 is a communication interface for communicating with the user terminal 200. The communication unit 303 can communicate with the user terminal 200 using the same communication standard that the communication unit 203 uses.

Next, a flow for unlocking a security lock on the in-vehicle device 100 will be described. When the user brings a locked in-vehicle device 100 to a car dealer, the car dealer first confirms that the in-vehicle device is not a stolen device and, then, starts the procedure for unlocking the in-vehicle device.

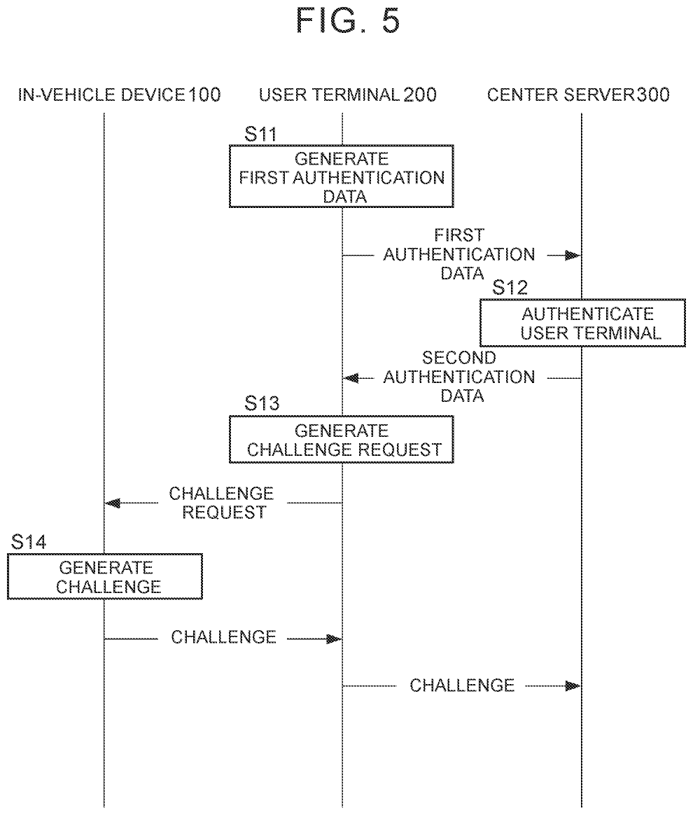

FIG. 5 is a flow diagram showing the data flow from the time the user terminal 200 generates the first authentication data for use in receiving authentication from the center server 300 to the time the in-vehicle device 100 generates a challenge based on a request from the user terminal 200.

First, in step S11, the user terminal 200 (first authentication unit 2011) generates the first authentication data. The first authentication data may be a password or a digital certificate. When the first authentication data is a password, the user terminal 200 may acquire the character string via the input/output unit 204. The generated first authentication data is sent to the center server 300 (second authentication unit 3011).

In step S12, the center server 300 (the second authentication unit 3011) authenticates the user terminal 200 based on the received first authentication data. When the first authentication data is a password, the hashed password may be used for comparison. When the first authentication data is a digital certificate, digital certificate identity may be verified.

When the user terminal 200 is successfully authenticated, the second authentication unit 3011 generates second authentication data. The second authentication data may be any data that allows the user terminal 200 to recognize that the authentication has succeeded. The second authentication data is sent to the user terminal 200 (the request unit 2012).

In step S13, the request unit 2012 that has received the second authentication data generates a challenge request. The challenge request may be fixed data or may be data that varies according to a session/terminal as long as the in-vehicle device 100 can verify its validity.

In addition, the challenge request may be the second authentication data itself. That is, the challenge request may be data generated only when authentication is established between the user terminal 200 and the center server 300. The challenge request may also be data encoded with the private key of the center server 300. In this case, the in-vehicle device 100 can decode the challenge request using the public key of the center server 300 to confirm that the challenge request has been generated by the center server 300.

In step S14, the in-vehicle device 100 (the security unit 1012) generates a challenge based on the received challenge request. The challenge may be a random character string with a predetermined number of digits. The generated challenge is sent to the center server 300 via the user terminal 200. When there is a plurality of types of in-vehicle devices 100 each of which uses a different hash function, the in-vehicle device 100 may send, together with the challenge, the information identifying the hash function to be used.

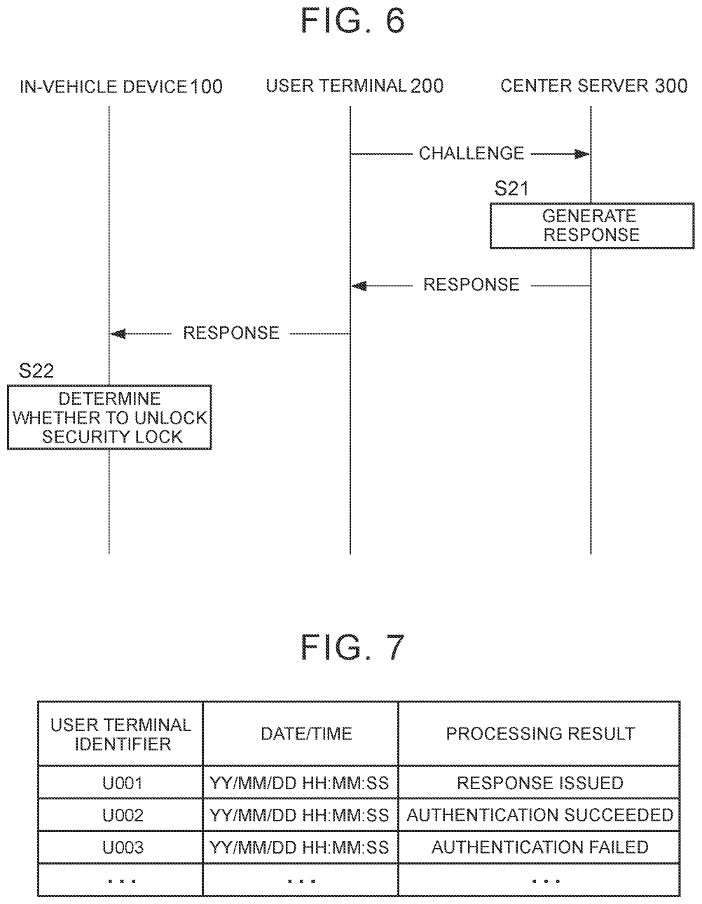

FIG. 6 is a flow diagram showing the data flow from the time the center server 300 generates a response based on the received challenge to the time the in-vehicle device 100 verifies the response.

In step S21, the center server 300 (the calculation unit 3012) generates a response corresponding to the received challenge. The calculation unit 3012 uses the hash function, stored in the storage unit 302, to generate a response corresponding to the received challenge, and sends the generated response to the in-vehicle device 100 via the user terminal 200. When there is a plurality of hash functions used in the system, the center server 300 may identify the hash function to be used based on the data sent from the in-vehicle device 100.

In step S22, the in-vehicle device 100 (the security unit 1012) verifies the received response and determines whether to unlock the security lock. More specifically, the in-vehicle device 100 compares the result, generated by encoding the challenge, which was generated by itself, using the hash function stored in the storage unit 102, and the received response. If they match, the security lock is unlocked.

As described above, in the authentication system according to the first embodiment, the user terminal 200 performs authentication with the center server 300 and, only when the authentication is successful, issues a challenge request to the in-vehicle device 100. This configuration makes it possible to prevent an unauthorized terminal (a terminal that has not been authenticated by the center server 300) from issuing a challenge request, preventing an attack that estimates the hash function.

### Second Embodiment

In the first embodiment, the center server 300 issues a response on condition that the center server 300 has successfully authenticated the user terminal 200. In the first embodiment, there is no limit on the number of times is a response is issued. On the other hand, in the second embodiment, there is a limit on the number of times a response is issued for each of the user terminals 200.

In the second embodiment, the center server 300 stores, for each of the user terminals 200, the number of times a request is received from that user terminals 200. More specifically, the center server 300 stores a table (history table), such as the one shown in FIG. 7, in the storage unit 302 and updates the table in step S12 or step S21. The history table is a table that records the identifier of the user terminal 200 from which a request was received, the date and time at which the request was received, and the processing result for the request. From this history table, the center server 300 can acquire, for each of the user terminal 200, when a request was received and what type of processing was performed (whether a response was issued, whether only the second authentication was performed, or whether the second authentication failed).

In the second embodiment, when a request is received from the user terminal 200, the calculation unit 3012 refers to the history table and, when an abnormal activity is detected, stops generating a response. For example, when the user terminal 200 that sends an authentication request has already received authentication (step S12 in FIG. 5) a predetermined number of times or more, or when a response has already been generated for that user terminal 200 (step S21 in FIG. 6) a predetermined number of times or more, within the predetermined period, the calculation unit 3012 determines that an abnormal activity is detected. In this case, the calculation unit 3012 stops the processing for the user terminal 200. This configuration makes it possible to deal with an attack that uses a legitimate user terminal 200 to attempts to illegally obtain a large amount of responses with an intention of estimating the hash function.

Modification

The above embodiment is merely an example, and the present disclosure may be modified as necessary for implementation without departing from the spirit of the present disclosure. For example, the processing and means described in the present disclosure can be freely combined for implementation as long as there is no technical contradiction.

Although the in-vehicle device 100 generates a challenge in response to a challenge request in this embodiment, the in-vehicle device 100 may verify the validity of the terminal that has sent the challenge request considering a case in which the challenge request is illegally copied. In other words, if the terminal that has sent a challenge request is not the user terminal 200 that has completed authentication with the center server 300, the in-vehicle device 100 may not need to respond to the challenge request.

Furthermore, the processing described as being performed by one device may be divided among two or more devices. Conversely, the processing described as being performed by different devices may be performed by one device. In a computer system, it is possible to flexibly change the hardware configuration (server configuration) to implement each function.

The present disclosure can also be implemented by supplying a computer with a computer program that implements the functions described in the above embodiment and by causing one or more processors of the computer to read and execute the program. Such a computer program may be provided to the computer by a non-transitory computer-readable storage medium that can be connected to the system bus of the computer or may be provided to the computer via a network. The non-transitory computer-readable storage medium includes, for example, any type of disk, such as a magnetic disk (floppy (registered trademark) disk, hard disk drive (HDD), etc.) and an optical disc (CD-ROM, DVD disc, Blu-ray disc, etc.), and any type of medium suitable for storing electronic instructions such as a read only memory (ROM), a random access memory (RAM), an EPROM, an EEPROM, a magnetic card, a flash memory, and an optical card.

What is claimed is:

1. An authentication system comprising a first information processing device and a second information processing device for requesting an authentication device to perform first authentication based on a challenge-response method, wherein:
the first information processing device is configured to perform second authentication with the second information processing device and is configured to request the authentication device to issue a challenge on condition that the second authentication is established; and
the second information processing device is configured to generate a response corresponding to the challenge issued by the authentication device.

2. The authentication system according to claim 1, wherein the second information processing device is configured to generate the response on condition that the second authentication is established.

3. The authentication system according to claim 1, wherein the first information processing device is configured to transfer a response to the authentication device, the response being generated by the second information processing device.

4. The authentication system according to claim 1, wherein the first information processing device is configured to transfer the challenge to the second information processing device to request the second information processing device to issue a response, the challenge being issued by the authentication device.

5. The authentication system according to claim 4, wherein:
the authentication system includes a plurality of the first information processing devices; and
the second information processing device is configured to store a history of response request reception for each of the plurality of the first information processing devices.

6. The authentication system according to claim 5, wherein the second information processing device is configured to stop issuing a response for the first information processing device that has requested a response more than a predetermined number of times within a predetermined time.

7. The authentication system according to claim 5, wherein the second information processing device is a center server that manages the plurality of the first information processing devices.

8. The authentication system according to claim 4, wherein the first information processing device is configured not to present the challenge to an operator, the challenge being issued by the authentication device.

9. The authentication system according to claim 1, wherein the authentication device is an in-vehicle device.

10. An authentication system comprising an authentication device, a first information processing device, and a second information processing device, wherein:
the authentication device is configured to issue a challenge, to acquire a response corresponding to the challenge, and to perform first authentication based on the issued challenge and the acquired response;
the first information processing device is configured to perform second authentication with the second information processing device and is configured to request the authentication device to issue a challenge on condition that the second authentication is established; and
the second information processing device is configured to generate a response corresponding to the challenge issued by the authentication device.

11. The authentication system according to claim 10, wherein the authentication device is configured not to issue the challenge in response to a request from a device other than the first information processing device that has received the second authentication.

12. The authentication system according to claim 10, wherein the second information processing device is configured to generate the response on condition that the second authentication is established.

13. The authentication system according to claim 10, wherein the first information processing device is configured to transfer a response to the authentication device, the response being generated by the second information processing device.

14. The authentication system according to claim 10, wherein the first information processing device is configured to transfer the challenge to the second information processing device to request the second information processing device to issue a response, the challenge being issued by the authentication device.

15. The authentication system according to claim 14, wherein:
the authentication system includes a plurality of the first information processing devices; and
the second information processing device is configured to store a history of response request reception for each of the plurality of the first information processing devices.

16. The authentication system according to claim 15, wherein the second information processing device is configured to stop issuing a response for the first information processing device that has requested a response more than a predetermined number of times within a predetermined time.

17. The authentication system according to claim 15, wherein the second information processing device is a center server that manages the plurality of the first information processing devices.

18. The authentication system according to claim 14, wherein the first information processing device is configured not to present the challenge to an operator, the challenge being issued by the authentication device.

19. The authentication system according to claim 10, wherein the authentication device is an in-vehicle device.

20. The authentication system according to claim 18 wherein, when the authentication device is removed from a vehicle, the authentication device is configured to stop a predetermined function thereof until the first authentication succeeds.
